(19) United States
(12) Patent Application Publication
(10) Pub. No.: US 2016/0363911 A1
(43) Pub. Date: Dec. 15, 2016

(54) CALENDAR EVENT TIME ZONE PREVIEW

(71) Applicant: BLACKBERRY LIMITED, WATERLOO (CA)

(72) Inventors: Vitaliy BELITSKY, Montreal (CA); Martin CHAKIROV, Trelleborg (SE)

(21) Appl. No.: 14/737,765

(22) Filed: Jun. 12, 2015

(51) Int. Cl. G04G 9/00; G04G 15/00; G04G 21/00; H04L 29/08

(52) U.S. Cl. CPC G04G 9/0076; H04L 67/18; G04G 15/006; G04G 21/00

(57) ABSTRACT

A system and method to view schedule entry information. An event schedule display includes a start time input that is configured to receive a first start time. The first start time has an associated first time zone. The event schedule display has a time zone selection input is configured to receive an indication of a user selectable number of respective user selected time zones. The event schedule display further has a remote time zone start time display that is configured to display a plurality of remote start times that correspond to the first start time in each of the user selectable number of user selected time zones.

### FIELD OF THE DISCLOSURE

The present disclosure generally relates to user interfaces for entering events, and more particularly to previewing local times of events in different time zones.

### BACKGROUND

Scheduling systems are used to track and monitor many types of upcoming events. For example, electronic calendar programs are used to maintain a person's schedule for events such as meetings and the like. In some circumstances, events are entered into an electronic calendar that affect multiple people or that may occur in a different time zone that is different than the person's current time zone when creating the event entry. Manual conversion of a particular time into the corresponding time in a different time zone can be inconvenient and prone to error. Modern circumstances include events such as conference calls that include participants that are present in different time zones. In one example, booking a conference call with people in other time zones it is not easy to quickly see which time works for all parties and the current system requires the user to do mental math to calculate the most appropriate time (i.e. not picking time that is during the night for example). This problem is compounded when the user has to book across more than two time zones.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 illustrates an electronic device with a user interface suitable for displaying an event schedule item, according to an example;

FIG. 2 illustrates an event schedule entry user interface, according to an example;

FIG. 3 illustrates a time zone selection interface, according to an example;

FIG. 4 illustrates an event time zone preview display, according to an example;

FIG. 5 illustrates a meeting schedule creation interface, according to an example;

FIG. 6 illustrates a time zone preview process, according to an example; and

FIG. 7 is a block diagram of an electronic device and associated components in which the systems and methods disclosed herein may be implemented.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function. In the following discussion, “handheld” is used to describe items, such as “handheld devices,” that are sized, designed and otherwise configured to be carried and operated while being held in a human hand or hands.

The below described systems and methods facilitate creating, viewing, or otherwise maintaining scheduling program event items, such as calendar entries, for events that may occur in different time zones the time zone in which the user is familiar, such as the user's current time zone, or calendar entries that include simultaneous activities in different time zones. In an example, an event entry in a scheduling program provides a preview of the corresponding times in different time zones that correspond to the time at which the event will occur in one time zone, such as the user's current time zone. In an example, a user is able to pick time zones from a popup user interface element and there is no limit as to the number of time zones they are able to be chosen to preview. In an example, the corresponding times for an event are shown for only the user selected time zones. This allows the user to view the corresponding time of the event in all of the time zones of interest without unnecessary clutter of other time zones. This convenient display of the corresponding times in other time zones further allows the user to see how a selected time will fit into the expected availability of persons in other time zones. In some examples, the start time, end time, or combinations of those, are able to be set while the display of the corresponding times in the selected time zones is able to be immediately updated to allow a user to easily adjust and find the best possible time that works for all parties. Further use examples include allowing a person who expects to travel to another time zone to figure out the best time to schedule an event when he or she is in that other time zone.

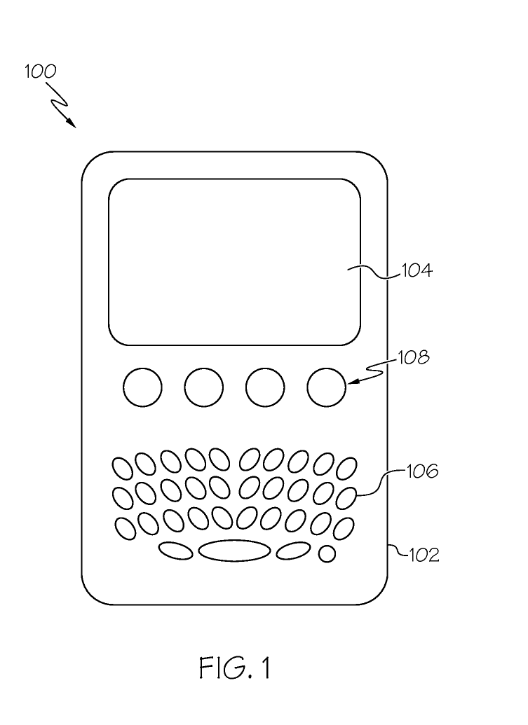

FIG. 1 illustrates an electronic device 100 with a user interface suitable for displaying an event schedule item, according to an example. The electronic device 100 in this example includes sufficient processing resources to implement the below described user interface elements and processes. The electronic device 100 is merely presented as an example of a device that is able to implement the below described examples. It is to be understood that the below described examples are able to be implemented with any suitable equipment, such as desktop computers, tablet computing devices, devices with any suitable user interface, or combinations of these.

The electronic device 100 includes a body 102 that contains electronic processing components to perform any desired functions for the electronic device. The body 102 has a display 104 that is used to present alphanumeric and graphical data to a user. In some examples, the display 104 includes touch sensitive input facilities that allow a user to provide inputs by touching the display at certain locations, such as locations presenting user interface elements indicating particular actions to take when the display 104 is touched in the area of that user interface element. In further examples, the display 104 does not include touch sensitive input facilities and user inputs are able to be provided by other facilities that are either part of the electronic device 100, or separate from but in communications with the electronic device 100.

The illustrated electronic device 100 further has a keyboard 106. The keyboard 106 is able to be a physical keyboard with mechanical buttons, or another type of keyboard such as a keyboard image displayed on a touch sensitive display. In general, the below described user interfaces and processes can be performed in conjunction with devices including any suitable user input facilities, such as a keyboard 106 of any form, other user input facilities, or combination of these. The illustrated electronic device 100 further has a row of additional input keys 108. These additional input keys 108 are able to be fixedly assigned dedicated functions, dynamically assigned different functions as may be indicated on the display 104, be assigned any function, or combinations of these.

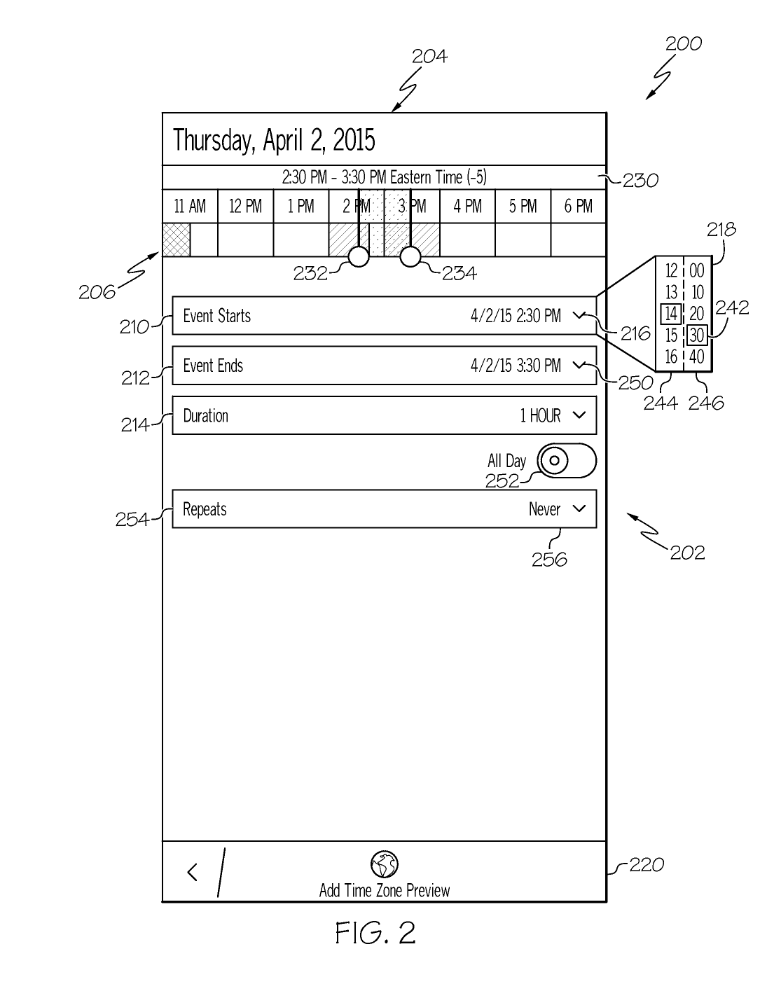

FIG. 2 illustrates an event schedule entry user interface 200, according to an example. The event schedule entry user interface 200 is an example of a user interface presented by, a computer application such as a calendar or scheduling program to allow a user to enter information about an event scheduled in the future. Such an event may be, for example, a televised presentation that is expected to be seen in multiple time zones. In order to facilitate selection of an effective time for such a televised presentation, it is helpful to know the local time in the time zones in which the televised presentation is expected to be seen. Although the following description is directed to a user interface for entering the schedule information of an event, it is clear that a similar user interface is able to be used to view the information for an already scheduled event, or to enter or view scheduling information regarding any type of action or activity.

The event schedule entry user interface 200 has an event entry user interface 202. In various examples, the event entry user interface 202 is able to be presented on a computer display in a window, in a pop-up window, or in any other presentation form. In a further example, the event entry user interface 202 is able to be presented on the display of a portable electronic device, such as a cell phone or other such device.

The event entry user interface 202 includes a date banner 204 that displays a date. In various examples, the date banner is able to display the present date while in other examples the date banner 204 does not display the present date but rather the date in the future of the event being scheduled.

The event entry user interface 202 further has an event start time entry field 210. The event start time entry field is an example of a start time input that is configured to receive a first start time by allowing a user to select a start time for the event, including the date of the event. In some examples, the time displayed in the event start time entry filed 210 is the time in the local time zone for the user of the device presenting the event entry user interface 202. In such an example, the first start time is said to have an associated first time zone that is the local time zone for the user. In further examples, the start time is able have any associated time zone.

An event start time in various examples is able to be entered into the event start time entry field 210 through any suitable technique as are known by practitioners of ordinary skill in the relevant arts in light of the present description. For example, selecting an entry start time input icon 216, such as by tapping, pressing, clicking, or using any other user interface functionality, in the illustrated event start time entry field 210 causes a time entry pop up display 218 to be displayed. The time entry pop up display 218 in the illustrated example presents a list of hours 244 and minutes 246 from which a start time is able to be selected. The illustrated example depicts that “14” is selected as the hour, and “30” is selected as the minutes for the even start time. This is reflected as the “2:30 PM” value displayed in the event start time entry field 210, since 14 hours corresponds to 2 PM in the twenty four hour clock. Similar input operations are able to be used to enter the date of the event start time. In an example, selecting the entry start time input icon 216 after setting the hours and minutes of the event causes the time entry pop up display 218 to be removed from the event entry user interface 202 and the selected time is entered into the event start time entry field 210.

The event entry user interface 202 further as an event end time entry field 212. The event entry user interface 202 is an example of an end time input configured to receive a first end time and operates in a manner similar to that described above for the event end time entry field 212. In an example, an entry end time input icon 250 is able to be selected and a time entry pop up display 218 is presented to allow a user to select the end time for the event. In an example, the end time entered in to the event end time entry field has the same associated time zone as the start time entered above, which is the local time zone for the user device.

The event entry user interface 202 further has an event duration entry field 214. The event duration entry field is able to be used in some examples as an alternative to the event end time entry field 212. In such examples, the user is able to select a duration for the event and enter this value into the event duration entry field 214. The duration is added in some examples to the event start time to automatically determine the event end time for scheduling purposes. In some examples, when a user enters the event duration into the event duration entry field 214, the corresponding event end time is automatically calculated and displayed in the event end time entry field 212. Conversely, when a user enters an event end time into the event end time entry field 212, the corresponding duration, i.e., the time between the entered event start time and the entered event end time, is automatically calculated and displayed in the event duration entry field 214. As another alternative to entering a duration, an “All day” user interface switch 252 is able to be selected to indicate that the event will last for the entire data selected in, for example, the event start time entry filed 210. Events are also able to be selected as “repeating” in a Repeats input filed 254. A repeating time period input 256 is able to specify how often the event repeats in the schedule. The depicted example shows the repeating time period to equal “never” which means only one event entry is made in the schedule. As is understood by practitioners of ordinary skill in the relevant arts, the Repeats input field 254 is able to configure various definitions of event repetitions.

The event entry user interface depicts a timeline 206 with a start time indicator 232 and a end time indicator 234. The timeline 206 in one example presents a graphical depiction of events scheduled for the day of the event start time specified in the event start time entry field 210. The start time indicator 232 presents a graphical indication on the timeline 206 of the event start time specified in the event start time entry field 210. The end time indicator 234 presents a graphical indication on the timeline 206 of the event end time specified in the event end time entry field 212. The event entry user interface 202 in an example has a local time zone indicator 230 that indicates the time zone used for the event times being entered and displayed. In the illustrated example, the local time zone indicator 230 indicates that the local time zone is “Eastern Time (−5)” and also shows the event start and end times in that time zone. The “(−5)” in this example indicates, as is common in indicating time zones, that this time is currently five hours less than Universal Coordinated Time (UTC).

The event entry user interface 202 further has a time zone preview button 220. The time zone preview button 220 allows a user to select time zones for which times corresponding to the event start time and event end times are to be displayed. In an example, selection of the time zone preview button 220, such as by tapping, pressing, clicking, or using any other user interface functionality, causes another user interface to be presented to allow the user to select particular time zones. The time zone preview button 220 is an example of a time zone preview user interface element. As described below, selection of additional time zones through that user interface allows a concise presentation of corresponding times for the selected event start and end times in only the time zones of interest to the user. This presentation of selected time zones helps the user select effective times for events that are expected to have participants in different time zones without extraneous information, such as the corresponding times of the event start and end times in time zones that are not of interest.

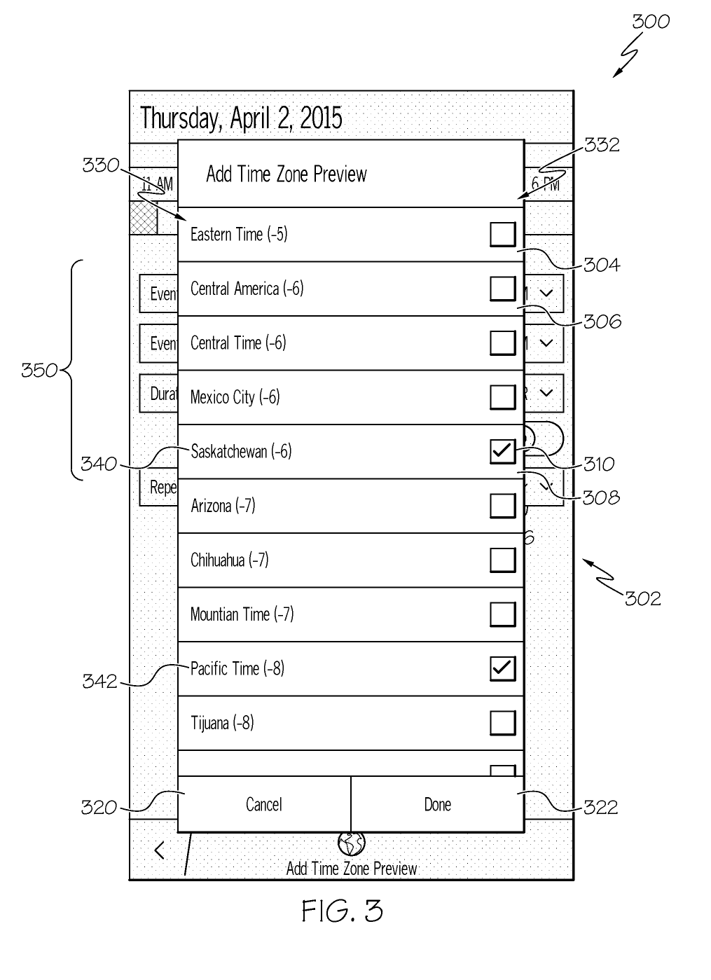

FIG. 3 illustrates a time zone selection interface 300, according to an example. The time zone selection interface 300 is an example of a user interface presented when a user selects the time zone preview button 220, described above. The illustrated time zone selection interface 300 in an example of a time zone user interface element that is selectably displayed based on selection of the time zone preview button and that allows a user to select particular time zones that are of interest in selecting event start and end times for a particular event.

The time zone selection interface 300 depicts a time zone selection display 302. The time zone selection display 302 is able to be, for example, a pop up window that is displayed when a user selects the time zone preview button 220, as is described above. The time zone selection display 302 has a time zone column 330 that includes a list of a plurality of time zones. Each time zone listed in the time zone column 330 has an associated selection element, such as the selection icons in the illustrated selection icon column 332. In an example, any one or more time zones listed in the time zone column 330 is able to be selected by, for example, clicking on a selection icon in the selection icon column 332 that is in the row of the desired time zone specified in the time zone column 330. Selecting a time zone in the time zone column by selecting its associated selection icon is an example of the time zone selection input receiving an indication of a user specified time zone.

The example time zone selection display 302 illustrates a portion of the available time zones that are able to be selected. In an example, the time zone selection display allows scrolling of the presented data view other time zones that are able to be selected. Scrolling of the presented data is able to be performed by any suitable user input, such as using arrow keys, pointer control inputs, touch screen gestures such as swiping, any other input, or combinations of these.

The illustrated time zone selection display 302 depicts a first selected time zone 340, which is listed as “Saskatchewan (−6)” in the time zone column 330. The time zone column in this example indicates a city in the time zone, Saskatchewan in this example. The number in parentheses in this example is the number of hours that the time zone differs from Universal Coordinated Time (UTC), as is common in specifications of time zones. A first selected selection icon 310 is depicted as being “checked” to show the user has selected the time zone associated with that icon. A second selected time zone 342 is also shown, which is listed as “Pacific Time (−8)” in the time zone column 330. The second selected time zone 342 is specified by the name commonly given that time zone, as opposed to a city in the time zone as is the case for the first selected time zone 340. It is clear that time zones are able to be effectively specified by either a city in the time zone, or by the name of the time zone, or both, in order to more conveniently present time zone options to a user when selecting times zones through the time zone selection display. As depicted by the time zone selection display, a central time zone group 350 is presented that has four entries for the time zone that is offset from UTC by −6 hours. That time zone is referred to as Central Time and that option is presented in the central time zone group 350. Major cities in that time zone are also presented, i.e., Mexico City and Saskatchewan. Listing major cities is able to help a user select a desired time zone in cases where the user may now be certain of the time zone in which a major city is located.

Time zones selected by a user in the time zone selection display 302, such as by selection of an associated time zone selection icon, are referred to as user selected time zones. The number of time zones selected by the user, such as the two user selected time zones illustrated in the time zone selection display 302, is referred to as the user selectable number of respective user specified time zones. In an example, the user selectable number of respective user selected time zones is based upon a number of time zones selected during the display of the time zone user interface element, such as the two time zones in this illustrated example. The illustrated selection of these two time zones via the time zone selection display 302 is an example of the time zone selection input receiving a user selectable number (i.e., 2 in this example) of respective user specified time zones.

The time zone selection display 302 includes a Cancel button 320 and a Done button 322. In an example, selecting the Cancel button 320 by an appropriate user interface action causes any action taken in the time zone selection display to be cancelled. Selecting the Done button 322 in an example causes an indication of those user selected time zones to be provided for further processing, such as the display of the times in those user selected time zones that correspond to the specified event start and end times, as is described below. In an example, selecting the Done button 322 to close the time zone selection display 302 is an example of the time zone user interface element being, once displayed, selectably closed by the user.

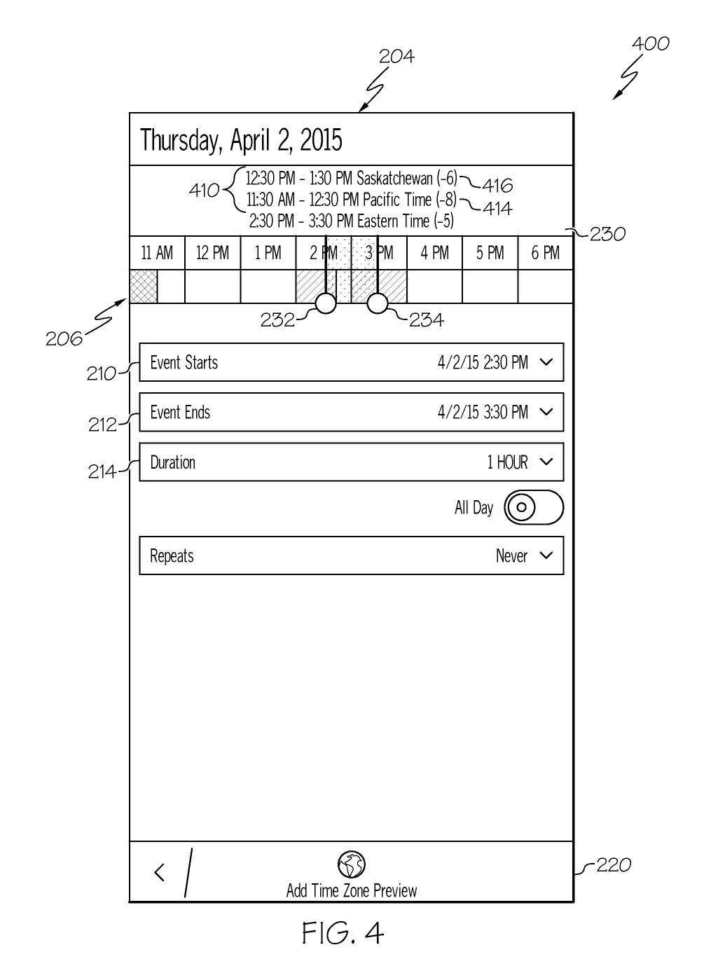

FIG. 4 illustrates an event time zone preview display 400, according to an example. The event time zone preview 400 is similar to the above described event schedule entry user interface 200 but further displays the corresponding times in selected time zones for the specified event start and end times. The event time zone preview display 400 is displayed in an example based on the user selecting the Done button 322 in the time zone selection display 302.

The event time zone preview display 400 in an example includes the above described event start time entry field 210, the event end time entry field 212, and the event duration entry field 214. The event time zone preview display 400 also includes the above described timeline 206 with the event start time indicator 232 and the event end time indicator 234 that displays event related times in the time zone associated with the user viewing the event time zone preview display.

In addition, the event time zone preview display 400 includes a time zone preview 410 that lists the times in user selected time zones that correspond to the event start time and the event end time. The times in the user selected time zones that correspond to the specified start time in the local time zone are examples of remote start times, and the times in the user selected time zones that correspond to the specified end time in the local time zone are examples of remote end times. The time zone preview 410 is an example of a remote time zone start time display that is configured to display a plurality of remote start times that are the start times corresponding to the first start time in each of the user selected time zones, and an example of a remote time zone end time field configured to display a plurality of remote end times, the plurality of remote end times comprising a respective end time corresponding to the first end time in each of the user selectable number of selected time zones. In an example, the time zone preview 410 is limited to displaying corresponding start times, end times, or both, in only the user selectable number of selected time zones. In an example, the event time zone preview display 400, including the time zone preview 410, is displayed based on the user selecting the Done button 322 in the time zone selection display 302. This is an example of the remote time zone start time field being displayed based on closing the time zone user interface.

The local time zone indicator 230 lists the event start and end time in the local time zone, i.e., the Eastern Time zone in this example. In addition to the local time zone, the user selected, via the time zone selection interface 300 discussed above, the user selected time zones indicated as “Saskatchewan” and “Pacific Time.”

The event time zone preview 410 has a first time zone preview line 416 that indicates the corresponding start and end times of the event in the “Saskatchewan” time zone along with an indication of that time zone (i.e., Saskatchewan). The event time zone preview 410 also has a second time zone preview line 414 that indicates the corresponding start and end times of the event in the “Pacific Time” time zone along with an indication of that time zone (i.e., Pacific Time).

The event time zone preview display 400 also includes the time zone preview button 220. A user is able to select the time zone preview button 220 and the time zone selection interface 300 is displayed as is described above. Once the time zone selection interface 300 is displayed again, the previously selected time zones, such as the Saskatchewan and Pacific Time zones in this example, remain selected. The user is then able to, for example, select additional time zones, unselect currently selected time zones, or both. Upon selecting the Done button in the time zone selection interface 300, an updated even time zone preview display 400 is presented with the different selected time zones included in the event time zone preview display 400.

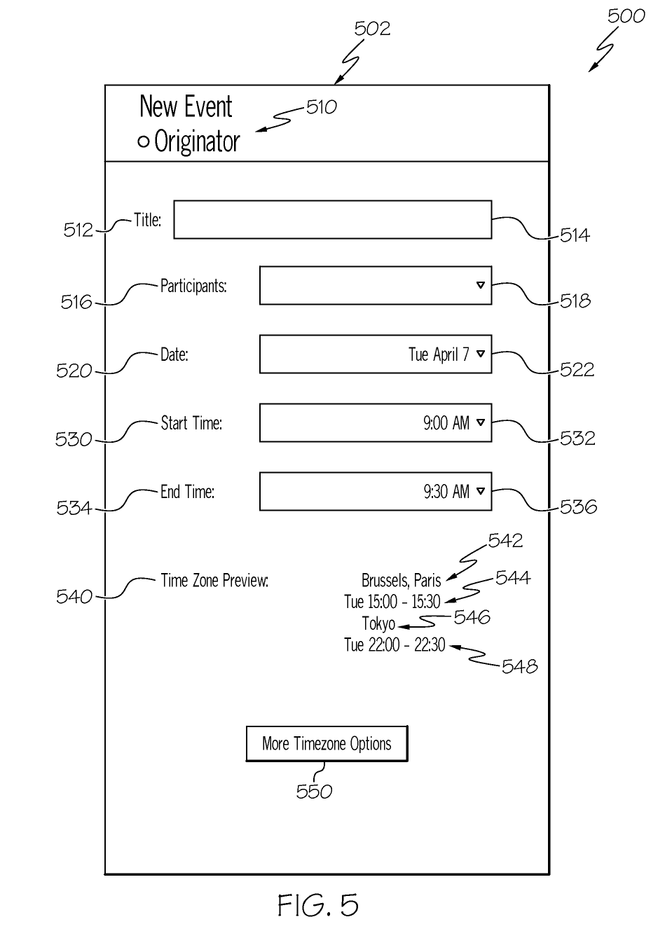

FIG. 5 illustrates a meeting schedule creation interface 500, according to an example. The meeting schedule creation interface 500 is an alternative example of a user interface that uses time zone previews in a manner similar to that described above. An example use of a meeting schedule creating interface 500 is setting up a conference call that is expected to include persons from multiple time zones. In general, the meeting schedule creation interface 500 is able to be used as an alternative interface to enter, view, modify, or otherwise maintain schedule information for any type of event, meeting, other activity, or combinations of these. The use of time zone previews as described herein facilitates selecting a time that is convenient, or at least generally acceptable, to participants in all of the expected time zones.

The meeting schedule creation interface 500 depicts a meeting schedule creation display 502. In various examples, the meeting schedule creation display 502 is able to be a window on a computer interface, a display on a portable electronic device, any suitable user interface display, or combinations of these. User interaction with the meeting schedule creation interface 500 is able to be by any suitable facilities, such as via a touch screen, keyboard, cursor control keys, other pointing manipulation devices, any other user interface device or technique, or combinations of these.

The meeting schedule creation display 502 includes a header 510 that indicates that this is an entry for a new event and further indicates the “originator” of the event. In an example, the “originator” is able to be a name or other indicator, such as an e-mail address, of the person entering the event schedule information. A title line 512 allows the user to enter a title into a title entry field 514 to identify the event or meeting. A participants line 516 allows a user to specify a list of participants in the participant input field 518. In general, any number of participants is able to be entered for the meeting or event in this example.

A start time line 530 allows a start time to be specified in a start time entry field 532. An end time line 534 allows an end time to be specified in an end time entry field 536. The start time line 530 and the end time line 534 operate similarly to the event start time entry field 210 and the event end time entry field 212 described above. The start time line 530 is a further example of a start time input configured to receive a first start time, and the end time line 534 a further example of an end time input configured to receive a first end time. A date line 520 allows the user to specify the date of the meeting. In this example, a start time is specified as 9:00 AM on Tuesday and an end time is specified as 9:30 AM on Tuesday. In this example, the user's local time zone is known by the user to be the Eastern Time zone and is not shown in the meeting schedule creation display 502. In this example, the received first start time and the received first end time have an associated first time zone that is the Eastern Time zone.

The meeting schedule creation display 502 includes a time zone preview portion 540 that lists corresponding start and end times for the event in selected time zones. In the illustrated example, the meeting is scheduled in the Eastern Time zone for 9:00 to 9:30 AM on Tuesday as is described above. This corresponds to a first corresponding time 544 of 15:00 to 15:30 hours also on Tuesday in the first selected time zone 542, which is indicated as “Brussels, Paris” in this example. This also corresponds to a second corresponding time 548 of 22:00 to 22:30 hours also on Tuesday in the second selected time zone 546, which is indicated as “Tokyo” in this example. In examples where the corresponding time in a selected time zone occurs on a different day, that different day is also indicated in the time zone preview portion 540.

The meeting schedule creation display 502 includes a more time zone options button 550. The MORE TIME ZONE OPTIONS button 550 operates similarly to the time zone preview button 220, described above, and in one example causes the time zone selection interface 300 to be displayed. The user is then able to select time zones in the time zone selection interface 300, as is discussed above, and upon selecting the Done button 322, the display returns to the meeting schedule creation display 502 and the time zone preview portion 540 is updated to show the corresponding even times in the newly selected time zones.

This example illustrates that the user is able to directly select the time zones for which corresponding times are shown. This has advantages over user interfaces that display the corresponding times in time zones that are usually associated with the listed participants of the meeting or event. For example, the user setting up the meeting or event may know that one or more participants will be travelling during the time of the meeting being scheduled and the associated time zone of that participant may not be accurate. For example, a scheduling system may show the specified times of the event times in a local time zone, which may be the Eastern Time zone, and show the corresponding time zone for a first listed participant who is normally in the Pacific Time zone. However, the person scheduling the event may know that the first listed participant will be travelling to the central time zone on the day of the meeting, and the corresponding time in the Pacific Time zone, as is displayed by some conventional systems, may not be relevant.

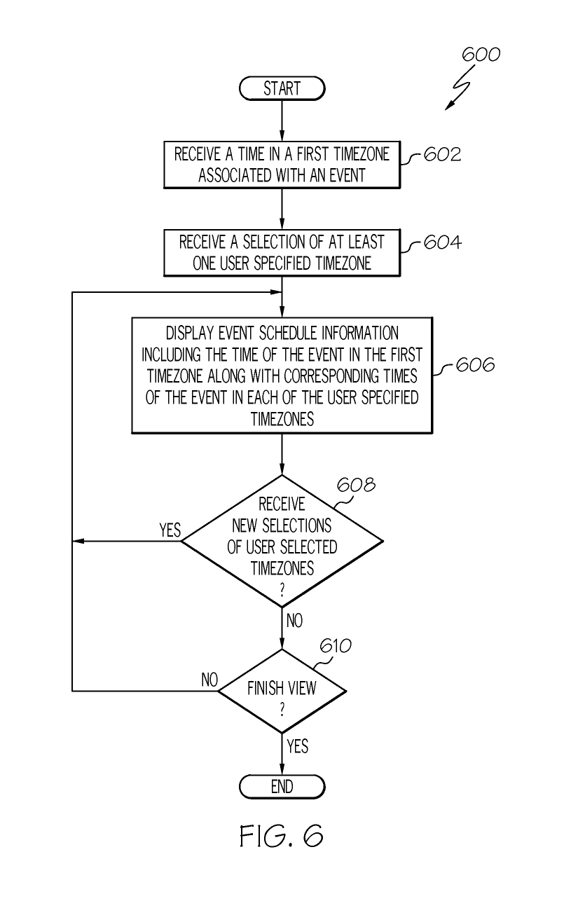

FIG. 6 illustrates a time zone preview process 600, according to an example. The time zone preview process 600 is an example of a process used to present the above described user interfaces. In an example, the time zone preview process 600 is performed by a portable electronic device 100 as is described above. In general, the time zone preview process 600 is able to be performed by any suitable device or any combination of device operating either together or separately.

The time zone preview process 600 begins by receiving, at 602, a time in a first time zone associated with an event. In various examples, the received time is able to be an event start time, an event end time, a combination of an event start time and event end time, any time that is associated with an event, or combinations of these. Particular examples of received event times include the time values entered by a user in the event start time entry field 210, the event end time entry field 212, the start time entry field 532, and start time entry field 536 described above.

The time zone preview process 600 receives, at 604, a selection of at least one user selected time zone. Examples of receiving at least one user selected time zone are described above with regards to the time zone selection interface 300. In general any number of user selected time zones are able to be selected by the user and thus received by the time zone preview process 600. In an example, two or more user selected time zones are able to be selected by the user via the time zone selection interface as is described above, and those two or more user selected time zones are then received by the time zone preview process 600.

The time zone preview process 600 displays, at 606, event schedule information associated with the event for which the time is received at 602. The display, at 606 includes the time of the event in the first time zone, as was received at 602. The time of the event in the first time zone is also displayed along with corresponding times of the event in each of the user selected time zones. Examples of displays of the corresponding time zones are described above with regards to the time zone preview 410 and time zone preview portion 540.

A determination is made, at 608, if new selections of user selected time zones are received. In an example, new selections of user selected time zones are able to be received when a user selects the time zone preview button 220, or the MORE TIME ZONE OPTIONS button 550, as described above when a display with an existing time zone preview is shown. Once one of these buttons is selected in an example, the time zone selection interface 300 is shown. This is an example of the time zone selection input being further configured to receive, subsequent to a display of the remote time zone start time display of the plurality of remote start times, a new selection of user selected time zones. Once the time zone selection interface 300 is shown, the user is then able to enter new selections of user selected time zones, and when the user selects the Done button 322, the time zone preview process 600 receives those new selections. If it is determined that new selections of user selected time zones have been received, the time zone preview process 600 returns to displaying the event information, at 606 with the corresponding times of the event in each of the new selection of user selected time zones.

If it is determined, at 608, that new selections of user selected time zones have not been received the time zone preview process 600 determines, at 610, if the user is finished with the view. This determination is able to be made based upon, for example, a user closing a window presenting event information that includes a time zone preview. If it is determined that the view is not finished, the time zone preview process 600 returns to displaying the event information, at 606. If it is determined that the view is finished, the time zone preview process 600 ends.

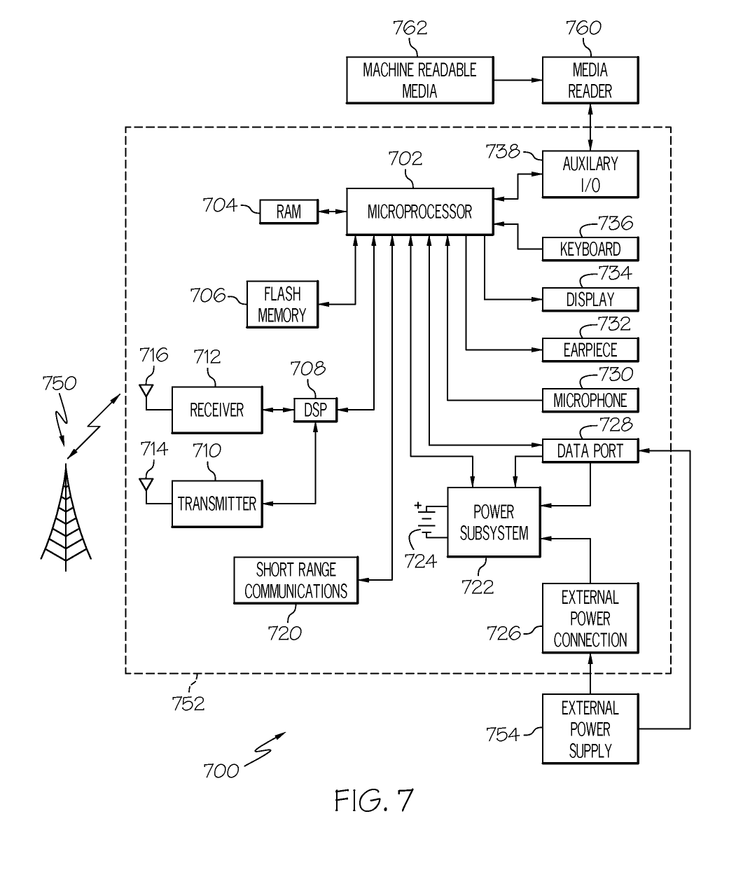

FIG. 7 is a block diagram of an electronic device and associated components 700 in which the systems and methods disclosed herein may be implemented. In this example, an electronic device 752 is also a wireless two-way communication device with voice, text chat, and data communication capabilities. Such electronic devices communicate with a wireless voice, text chat, or data network 750 using a suitable wireless communications protocol. Wireless voice communications are performed using either an analog or digital wireless communication channel Data communications allow the electronic device 752 to communicate with other computer systems via the Internet. Examples of electronic devices that are able to incorporate the above described systems and methods include, for example, a data messaging device, a two-way pager, a cellular telephone with text and data messaging capabilities, a wireless Internet appliance or a data communication device that may or may not include telephony capabilities.

The illustrated electronic device 752 is an example electronic device that includes two-way wireless communications functions. Such electronic devices incorporate communication subsystem elements such as a wireless transmitter 710, a wireless receiver 712, and associated components such as one or more antenna elements 714 and 716. A digital signal processor (DSP) 708 performs processing to extract data from received wireless signals and to generate signals to be transmitted. The particular design of the communication subsystem is dependent upon the communication network and associated wireless communications protocols with which the device is intended to operate.

The electronic device 752 includes a microprocessor 702 that controls the overall operation of the electronic device 752. The microprocessor 702 interacts with the above described communications subsystem elements and also interacts with other device subsystems such as flash memory 706, random access memory (RAM) 704, auxiliary input/output (I/O) device 738, data port 728, display 734, keyboard 736, earpiece 732, audio sound reproduction system 770, microphone 730, a short-range communications subsystem 720, a power subsystem 722, other subsystems, or combinations of these.

One or more power storage or supply elements, such as a battery 724, are connected to a power subsystem 722 to provide power to the circuits of the electronic device 752. The power subsystem 722 includes power distribution circuitry for providing power to the electronic device 752 and also contains battery charging circuitry to manage recharging the battery 724 (or circuitry to replenish power to another power storage element). The power subsystem 722 receives electrical power from external power supply 754. The power subsystem 722 is able to be connected to the external power supply 754 through a dedicated external power connector (not shown) or through power connections within the data port 728. The power subsystem 722 includes a battery monitoring circuit that is operable to provide a status of one or more battery status indicators, such as remaining capacity, temperature, voltage, electrical current consumption, and the like, to various components of the electronic device 752.

The data port 728 is able to support data communications between the electronic device 752 and other devices through various modes of data communications, such as high speed data transfers over an optical communications circuits. Data port 728 is able to support communications with, for example, an external computer or other device. In some examples, the data port 728 is able to include electrical power connections to provide externally provided electrical power to the electronic device 752, deliver electrical power from the electronic device 752 to other externally connected devices, or both. Data port 728 of, for example, an electronic accessory is able to provide power to an electronic circuit, such as microprocessor 702, and support exchanging data between the microprocessor 702 and a remote electronic device that is connected through the data port 728.

Data communication through data port 728 enables a user to set preferences through the external device or through a software application and extends the capabilities of the device by enabling information or software exchange through direct connections between the electronic device 752 and external data sources rather than via a wireless data communication network. In addition to data communication, the data port 728 provides power to the power subsystem 722 to charge the battery 724 or to supply power to the electronic circuits, such as microprocessor 702, of the electronic device 752.

Operating system software used by the microprocessor 702 is stored in flash memory 706. Further examples are able to use a battery backed-up RAM or other non-volatile storage data elements to store operating systems, other executable programs, or both. The operating system software, device application software, or parts thereof, are able to be temporarily loaded into volatile data storage such as RAM 704. Data received via wireless communication signals or through wired communications are also able to be stored to RAM 704.

The microprocessor 702, in addition to its operating system functions, is able to execute software applications on the electronic device 752. A set of applications that control basic device operations, including at least data and voice communication applications, is able to be installed on the electronic device 752 during manufacture. In an example, programs and other data used to support the processes described above are able to be installed in the memory of the electronic device 752. Further examples of applications that are able to be loaded onto the device may be a personal information manager (PIM) application having the ability to organize and manage data items relating to the device user, such as, but not limited to, e-mail, calendar events, voice mails, appointments, and task items.

Further applications may also be loaded onto the electronic device 752 through, for example, the wireless network 750, an auxiliary I/O device 738, Data port 728, short-range communications subsystem 720, or any combination of these interfaces. Such applications are then able to be installed by a user in the RAM 704 or a non-volatile store for execution by the microprocessor 702.

In a data communication mode, a received signal such as a text message or web page download is processed by the communication subsystem, including wireless receiver 712 and wireless transmitter 710, and communicated data is provided the microprocessor 702, which is able to further process the received data for output to the display 734, or alternatively, to an auxiliary I/O device 738 or the Data port 728. A user of the electronic device 752 may also compose data items, such as e-mail messages, using the keyboard 736, which is able to include a complete alphanumeric keyboard or a telephone-type keypad, in conjunction with the display 734 and possibly an auxiliary I/O device 738. Such composed items are then able to be transmitted over a communication network through the communication subsystem.

For voice communications, overall operation of the electronic device 752 is substantially similar, except that received signals are generally provided to an earpiece 732 and signals for transmission are generally produced by a microphone 730. Alternative voice or audio I/O subsystems, such as a voice message recording subsystem, may also be implemented on the electronic device 752. Although voice or audio signal output is generally accomplished primarily through the earpiece 732, the display 734 may also be used to provide an indication of the identity of a calling party, the duration of a voice call, or other voice call related information, for example.

Depending on conditions or statuses of the electronic device 752, one or more particular functions associated with a subsystem circuit may be disabled, or an entire subsystem circuit may be disabled. For example, if the battery temperature is low, then voice functions may be disabled, but data communications, such as e-mail, may still be enabled over the communication subsystem.

A short-range communications subsystem 720 provides for data communication between the electronic device 752 and different systems or devices, which need not necessarily be similar devices. For example, the short-range communications subsystem 720 includes an infrared device and associated circuits and components or a Radio Frequency based communication module such as one supporting Bluetooth® communications, to provide for communication with similarly-enabled systems and devices, including the data file transfer communications described above.

A media reader 760 is able to be connected to an auxiliary I/O device 738 to allow, for example, loading computer readable program code of a computer program product into the electronic device 752 for storage into flash memory 706. One example of a media reader 760 is an optical drive such as a CD/DVD drive, which may be used to store data to and read data from a computer readable medium or storage product such as computer readable storage media 762. Examples of suitable computer readable storage media include optical storage media such as a CD or DVD, magnetic media, or any other suitable data storage device. Media reader 760 is alternatively able to be connected to the electronic device through the Data port 728 or computer readable program code is alternatively able to be provided to the electronic device 752 through the wireless network 750.

Information Processing System

The present subject matter can be realized in hardware, software, or a combination of hardware and software. A system can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein.

The present subject matter can also be embedded in a computer program product, which comprises all the features enabling the implementation of the methods described herein, and which—when loaded in a computer system—is able to carry out these methods. Computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. Additionally, a computer medium may include volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Non-Limiting Examples

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

What is claimed is:

1. An event schedule display, comprising:
a start time input configured to receive a first start time, the first start time having an associated first time zone;
a time zone selection input configured to receive an indication of a user selectable number of respective user selected time zones; and
a remote time zone start time display configured to display a plurality of remote start times, the plurality of remote start times comprising a respective start time corresponding to the first start time in each of the user selectable number of user selected time zones.

2. The event schedule display of claim 1, further comprising:
an end time input configured to receive a first end time, the first end time associated with the first time zone; and
a remote time zone end time field configured to display a plurality of remote end times, the plurality of remote end times comprising a respective end time corresponding to the first end time in each of the user selectable number of user selected time zones.

3. The event schedule display of claim 1, further comprising:
a time zone preview user interface element; and
a time zone user interface element, the time zone user interface element comprising the time zone selection input and being selectably displayed to a user and, once displayed, selectably closed by the user,
wherein display of the time zone user interface element is based on selection of the time zone preview user interface element,
and wherein the user selected time zones are selected based on selections entered into the time zone user interface element, and
wherein the user selectable number of respective user selected time zones is based upon a number of time zones selected during the display of the time zone user interface element.

4. The event schedule display of claim 3, wherein the time zone user interface element comprises:
a list of a plurality of time zones, each time zone in the list of the plurality of time zones having an associated user selection element, and
wherein the remote time zone start time display is displayed based on closing the time zone user interface element.

5. The event schedule display of claim 1, wherein the remote time zone start time display is limited to displaying the respective start time corresponding to the first start time in the user selectable number of user selected time zones corresponding to the user selectable number of user selected time zones.

6. The event schedule display of claim 1, wherein the time zone selection input is further configured to receive, subsequent to a display of the remote time zone start time display of the plurality of remote start times, a new selection of user selected time zones, and
wherein the remote time zone start time display is further configured to display a plurality of new remote start times, the plurality of new remote start times comprising a respective start time corresponding to the first start time in each of the new selection of user selected time zones.

7. A method for displaying an event schedule, the method comprising:
receiving a first start time, the first start time having an associated first time zone;
receiving an indication of a user selectable number of respective user selected time zones; and
displaying a plurality of remote start times, the plurality of remote start times comprising a respective start time corresponding to the first start time in each of the user selectable number of user selected time zones.

8. The method of claim 7, further comprising:
receiving a first end time, the first end time associated with the first time zone; and
displaying a plurality of remote end times, the plurality of remote end times comprising a respective end time corresponding to the first end time in each of the user selectable number of user selected time zones.

9. The method of claim 7, further comprising:
displaying a time zone preview user interface element and a time zone user interface element, the time zone user interface element receiving the indication of the user selectable number of user selected time zones and further being selectably displayed to a user and, once displayed, selectably closed by the user,
wherein the displaying of the time zone user interface element is based on selection of the time zone preview user interface element, and
wherein the user selected time zones are selected based on selections entered into the time zone user interface element, and
wherein the user selectable number of respective user selected time zones is based upon a number of time zones selected during the display of the time zone user interface element.

10. The method of claim 9, wherein the time zone user interface element comprises:
a list of a plurality of time zones, each time zone in the list of the plurality of time zones having an associated user selection element, and
wherein the displaying of the plurality of remote start times is based on closing the time zone user interface element.

11. The method of claim 7, wherein the displaying of the remote start times is limited to displaying the respective start time corresponding to the first start time in the user selectable number of user selected time zones corresponding to the user selectable number of user selected time zones.

12. The method of claim 7, further comprising:
receiving, subsequent to displaying the remote start times, a new selection of user selected time zones; and
displaying a plurality of new remote start times, the plurality of new remote start times comprising a respective start time corresponding to the first start time in each of the new selection of user selected time zones.

13. A computer readable storage medium having computer readable program code embodied therewith, the computer readable program code comprising instructions for:
receiving a first start time, the first start time having an associated first time zone;
receiving an indication of a user selectable number of respective user selected time zones; and
displaying a plurality of remote start times, the plurality of remote start times comprising a respective start time corresponding to the first start time in each of the user selectable number of user selected time zones.

14. The computer readable storage medium of claim 13, wherein the instructions further comprise instructions for:
receiving a first end time, the first end time associated with the first time zone; and
displaying a plurality of remote end times, the plurality of remote end times comprising a respective end time corresponding to the first end time in each of the user selectable number of user selected time zones.

15. The computer readable storage medium of claim 13, wherein the instructions further comprise instructions for:
displaying a time zone preview user interface element and a time zone user interface element, the time zone user interface element receiving the indication of the user selectable number of user selected time zones and further being selectably displayed to a user and, once displayed, selectably closed by the user,
wherein the displaying of the time zone user interface element is based on selection of the time zone preview user interface element, and
wherein the user selected time zones are selected based on selections entered into the time zone user interface element, and
wherein the user selectable number of respective user selected time zones is based upon a number of time zones selected during the display of the time zone user interface element.

16. The computer readable storage medium of claim 15, wherein the time zone user interface element comprises:
a list of a plurality of time zones, each time zone in the list of the plurality of time zones having an associated user selection element, and
wherein the displaying of the plurality of remote start times is based on closing the time zone user interface element.

17. The computer readable storage medium of claim 13, wherein the displaying of the remote start times is limited to displaying the respective start time corresponding to the first start time in the user selectable number of user selected time zones corresponding to the user selectable number of user selected time zones.

18. The computer readable storage medium of claim 13, wherein the instructions further comprise instructions for:
receiving, subsequent to displaying the remote start times, a new selection of user selected time zones; and
displaying a plurality of new remote start times, the plurality of new remote start times comprising a respective start time corresponding to the first start time in each of the new selection of user selected time zones.
